(19) United States
(12) Patent Application Publication
(10) Pub. No.: US 2026/0031662 A1
(43) Pub. Date: Jan. 29, 2026

(54) WIRELESS CHARGING METHOD FOR INTELLIGENT QUADRUPED ROBOT

(71) Applicant: IXOVA INC, Dover, DE (US)

(72) Inventors: Kangming Geng, Hong Kong (HK); Angela Yijia Geng, Los Angeles, CA (US)

(21) Appl. No.: 19/342,688

(22) Filed: Sep. 29, 2025

Related U.S. Application Data
(63) Continuation of application No. 19/315,689, filed on Sep. 1, 2025, now abandoned.

(51) Int. Cl. H02J 50/90; G05D 1/661; G05D 109/12; H02J 50/12; H02J 50/40; H02J 50/60; H02J 50/80

(52) U.S. Cl. CPC H02J 50/90; G05D 1/661; H02J 50/12; H02J 50/402; H02J 50/60; H02J 50/80; G05D 2109/12

(57) ABSTRACT

A wireless charging method for an intelligent quadruped robot includes guiding the quadruped robot to the charging panel, detecting a surface condition of the charging panel via the detection device, generating a first signal once a foreign object is present on the charging panel, otherwise, generating a second signal, controlling the charging power supply in a turned-off state when in idle; remaining the charging power supply in the turned-off state based on the first signal; switching from the turned-off state to a turned-on state based on the second signal; and charging a rechargeable battery in the quadruped robot. The method achieves autonomous movement to reduce manual intervention, and prevents charging anomalies or hazards to ensure charging safety.

### CROSS REFERENCE TO RELATED APPLICATIONS

This application is a continuation application of U.S. application Ser. No. 19/315,689, filed on Sep. 1, 2025. The contents of the above-identified application are incorporated herein by reference.

### FIELD OF THE INVENTION

The present invention relates to the field of bionic robotics, and particularly to a wireless charging method for an intelligent quadruped robot.

### BACKGROUND OF THE INVENTION

With the rapid development of intelligent robotics, quadruped robots, as a type of bionic robot, are widely used in fields such as intelligent companion, search and rescue, and patrol. Intelligent quadruped robots typically rely on built-in rechargeable batteries as their power supply to support movement, sensing, and interaction functions. However, traditional charging methods mostly depend on wired charging interfaces, requiring manual intervention to connect the charger to the quadruped robot, which is not only cumbersome but also difficult to automate in certain scenarios (e.g., unattended environments).

In recent years, wireless charging technology has gradually emerged as an effective solution for robot charging. Wireless charging transmits electrical energy wirelessly through electromagnetic induction or resonance, which eliminates the need for physical connections and offers advantages in convenience and flexibility. However, the existing wireless charging technologies still face challenges when applied to the intelligent quadruped robots. For example, the quadruped robot must accurately position itself at a designated location on the charging station for efficient charging, yet the existing technologies lack effective navigation and location methods, resulting in low charging efficiency. Additionally, foreign objects (e.g., metal debris or liquids) on the charging panel may interfere with the wireless charging or even pose safety hazards, but the existing technologies lack real-time detection and feedback mechanisms for monitoring the condition of the charging panel.

### SUMMARY OF THE INVENTION

The objective of the present invention is to provide a wireless charging method for an intelligent quadruped robot that enables autonomous navigation to the charging position and ensures charging safety through environmental detection.

In order to achieve the objective mentioned above, the present invention provides a wireless charging method for an intelligent quadruped robot, the quadruped robot being equipped with a power receiver, a charging driver, a navigation device, a communication device, and a detection device. The wireless charging method includes:
providing a charging station, the charging station including a charging power supply and a charging panel electrically connected to the charging power supply, the charging panel being provided with a power transmitter capable of wirelessly transmitting an electrical energy signal;
guiding the quadruped robot to the charging panel based on the navigation device;
detecting a surface condition of the charging panel via the detection device, generating a first signal once a foreign object is present on the charging panel, otherwise, generating a second signal;
transmitting the first signal or the second signal to the charging power supply via the communication device;
controlling the charging power supply in a turned-off state when the charging power supply is idle; remaining the charging power supply in the turned-off state when the first signal is received; and switching the charging power supply from the turned-off state to a turned-on state when the second signal is received, thereby establishing a charging connection between the power transmitter and the power receiver; and
receiving, by the charging driver, the electrical energy signal from the power receiver to charge a rechargeable battery in the quadruped robot.

As an embodiment, the detection device includes a camera and/or a detection radar.

As an embodiment, a side of the quadruped robot is provided with a circuit board, and the power receiver is arranged on the circuit board.

As an embodiment, the quadruped robot is further provided internally with a cooling fan oriented toward the circuit board.

As an embodiment, the method further includes adjusting, by the charging driver, the charging power in real time by detecting parameters including voltage, current, and temperature of the rechargeable battery, and switching to a pulsed trickle charging mode when a battery capacity of the rechargeable battery reaches a preset value

As an embodiment, the method further includes automatically activating and guiding, by the navigation device, the quadruped robot to move to a location of the charging panel, when the battery level of the rechargeable battery is lower than a preset value.

As an embodiment, the method further includes continuously monitoring, by the detection device, a surface condition of the charging panel during a charging process, and generating the first signal once the foreign object is detected, and transmitting the first signal to the charging power supply via the communication device to interrupt the charging connection.

As an embodiment, the method further includes during a charging process, detecting an alignment state between the power receiver and the power transmitter and a charging efficiency, adjusting a position of the quadruped robot when the charging efficiency is lower than a preset value, and sending a signal to the charging power supply via the communication device to maintain or increase the charging power.

As an embodiment, the circuit board is integrated with a multi-coil array structure, and the method further includes dynamically switching an activated coil group via a relay matrix, in response to changes in coupling efficiency caused by positional or angular deviations of the charging panel.

As an embodiment, the communication device supports a bidirectional energy transfer protocol, and the wireless charging method further includes during a charging process, feeding back health state data of the rechargeable battery to the charging panel via frequency-shift keying modulation, and triggering the power transmitter to adjust a resonant frequency to match an energy reception window of the power receiver. First, the quadruped robot is integrated with the navigation device, thereby achieving autonomous movement to the charging panel, and greatly reducing the need for manual intervention. In unattended or complex environments, this significantly enhances the automation of the charging process, saving labor costs. Second, the surface condition of the charging panel is detected by the detection device in real time. Once foreign objects are detected, the charging power supply remains in the turned-off state, which prevents the charging anomalies or hazards such as short circuits, overheating, or even fires, thereby ensuring the charging safety.

### BRIEF DESCRIPTION OF THE DRAWINGS

The accompanying drawings facilitate an understanding of the various embodiments of this invention. In such drawings:

FIG. 1 illustrates a wireless charging state diagram of an intelligent quadruped robot according to an embodiment of the present invention; and

FIG. 2 illustrates a structural schematic of the wireless charging principle of an intelligent quadruped robot according to an embodiment of the present invention.

### DETAILED DESCRIPTION OF ILLUSTRATED EMBODIMENTS

To elaborate on the technical content, structural features, objectives, and effects of the present invention, the following detailed explanation is provided in conjunction with the implementation methods and accompanying drawings.

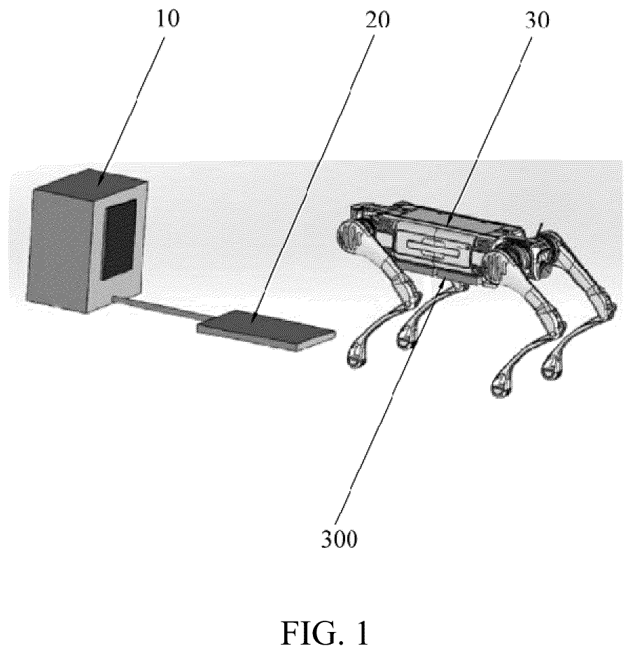

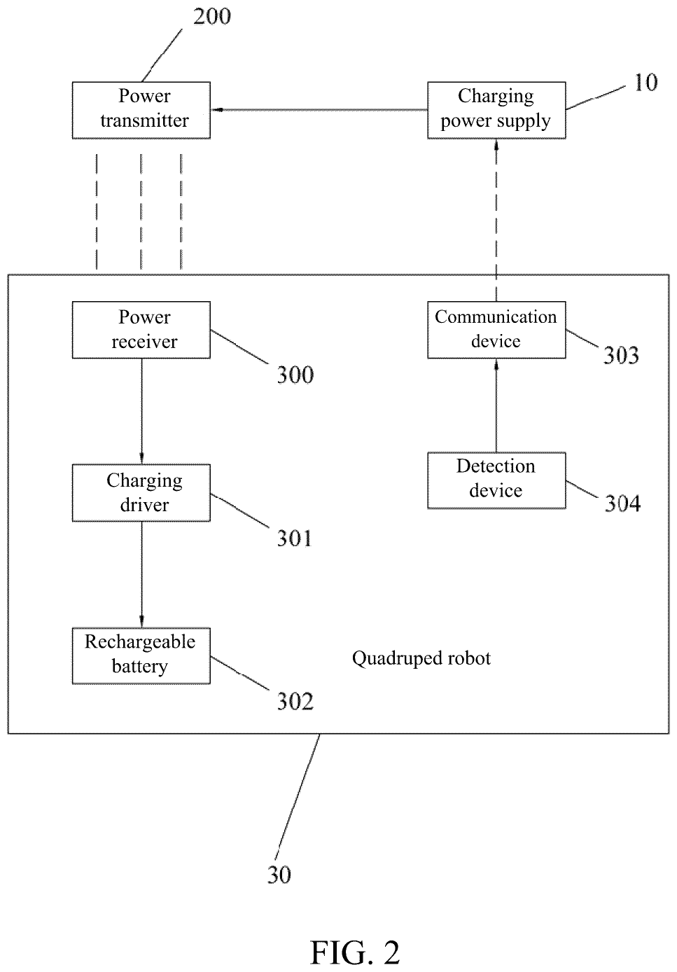

The embodiment of the present invention discloses a wireless charging method for an intelligent quadruped robot to control the quadruped robot 30 in performing wireless automatic charging. As shown in FIGS. 1 and 2, the quadruped robot 30 is equipped with a power receiver 300, a charging driver 301, a navigation device, a communication device 303, and a detection device 304.

The charging method in this embodiment includes the following steps:
providing a charging station including a charging power supply 10 and a charging panel 20 electrically connected to the charging power supply 10, the charging panel 20 being provided with a power transmitter 200 capable of wirelessly transmitting an electrical energy signal;
guiding the quadruped robot 30 to the charging panel 20 via the navigation device;
detecting a surface condition of the charging panel 20 via the detection device 304, generating a first signal once a foreign object is present on the charging panel 20, otherwise, generating a second signal;
transmitting the first or second signal to the charging power supply 10 via the communication device 303;
controlling the charging power supply 10 in a turned-off state when the charging power supply 10 is idle; remaining the charging power supply 10 in the turned-off state when the first signal is received; and switching from the turned-off state to a turned-on state when the second signal is received, thereby establishing a charging connection between the power transmitter 200 and the power receiver 300; and
receiving, by the charging driver 301, the electrical energy signal from the power receiver 300 to charge a rechargeable battery 302 in the quadruped robot 30.

The present invention can achieve wireless power transmission based on electromagnetic induction or resonance principles, and the power transmitter 200 is configured to convert an electrical energy into a high-frequency electromagnetic field, and the power receiver 300 is configured to induce and convert it back into the electrical energy.

The navigation device is configured to guide the quadruped robot 30 to position above the charging panel 20, ensuring a proper alignment between the power transmitter 200 and the power receiver 300 to optimize the energy transfer efficiency.

The detection device 304 is configured to scan the surface of the charging panel 20 to identify any foreign object, preventing the interference or potential safety risks during the wireless charging.

The communication device 303 is configured to perform data exchange between the quadruped robot 30 and the charging power supply 10, thereby enabling the intelligent on/off control of the charging power supply 10 to ensure charging only initiates under safe and obstruction-free conditions. The charging driver 301 is configured to efficiently convert the received electrical energy signal into the required charging current and voltage for the rechargeable battery 302, thereby ensuring the stable charging.

With the above charging method, the quadruped robot 30 is integrated with the navigation device, thereby achieving autonomous movement to the charging panel 20, and greatly reducing the need for manual intervention. In unattended or complex environments, this significantly enhances the automation of the charging process, saving labor costs. For instance, in factory inspections or warehouse management, the quadruped robot 30 can autonomously recharge without manual plugging/unplugging, thereby improving operational efficiency and system uptime.

Additionally, the surface condition of the charging panel 20 is detected by the detection device 304 in real time. Once foreign objects (e.g., metal debris or moisture) are detected, the charging power supply 10 remains in the turned-off state. Therefore, charging anomalies or hazards such as short circuits, overheating, or even fires are prevented, thereby ensuring the charging safety.

Moreover, the precise guidance of the navigation device can ensure accurate positioning of the quadruped robot 30 on the charging panel 20, thereby optimizing the alignment between the power transmitter 200 and power receiver 300. This reduces energy loss during wireless transmission, thereby improving charging efficiency by 10%-20% compared to manual alignment. Furthermore, the charging power supply 10 is activated only when the charging panel 20 is obstruction-free and idle, thus unnecessary energy waste is avoided, thereby enhancing the energy utilization efficiency and reliability of the system. This on-demand activation mechanism extends the lifespan of the charging power supply and reduces operational costs.

It should also be noted that the navigation device can employ various positioning technologies. In addition to vision-based and LiDAR-based SLAM technology, indoor positioning systems utilizing UWB (Ultra-Wideband) or RFID (Radio Frequency Identification) may also be adopted. By deploying beacons around the charging station or environment, centimeter-level positioning of the quadruped robot 30 can be achieved, thereby further enhancing navigation accuracy and robustness.

The communication device 303 may utilize low-power wireless communication technologies such as LoRa or Zigbee in addition to Wi-Fi and Bluetooth, to meet different communication ranges and power consumption requirements. The signal transmission method may also base on PLC (Power Line Communication) technology, transmitting control signals through power cables of the charging station to reduce additional communication modules. The start-stop control logic of the charging power supply 10 may be further optimized. For instance, upon receiving the first signal, in addition to maintaining the off state, an alarm mechanism may be triggered to notify users to remove the foreign objects or activate an automatic cleaning device.

The wireless charging technology of the power transmitter 200 and power receiver 300 may employ electromagnetic resonance in addition to electromagnetic induction, enabling longer charging distances and higher alignment tolerance. The charging driver 301 may integrate an intelligent charging management chip.

In a preferable embodiment, the detection device 304 includes a camera and/or detection radar.

In this embodiment, the camera serving as the detection device 304, utilizes its visual perception capabilities to identify various visible foreign objects on the surface of the charging panel 20 through image acquisition and processing technologies. The working principle of the camera is based on image recognition algorithms that analyze the captured images to determine whether preset foreign object characteristics are present, thereby generating corresponding signals.

Specifically, the camera is typically a high-resolution digital camera installed at the bottom of the quadruped robot 30, so as to capture real-time images of the charging panel 20. The camera projects the scene of the charging panel 20 onto an image sensor through an optical lens, which converts light signals into electrical signals and transmits them to an image processing unit. The image processing unit is incorporated with image recognition algorithms, such as deep learning-based object detection models (e.g., YOLO, Mask R-CNN), thereby enabling real-time analysis of pixel data in images to identify and classify the foreign objects on the charging panel 20, such as screws, coins, water droplets, or leaves, and generating the first or second signal based on the recognition results.

The detection radar (e.g., millimeter-wave radar), as another detection device 304, utilizes the reflection characteristics of electromagnetic waves to detect objects. It emits the electromagnetic waves and receives the signals reflected from the surface of the charging panel 20 or the foreign objects. By analyzing the time of flight of the signal, frequency shift, and intensity, the presence, position, size, and even material of the foreign objects can be accurately determined, particularly offering advantages for non-visible objects (e.g., thin films, low-reflectivity materials) or in low-light environments. The combination or individual application of these two detection methods provides reliable detection capabilities for the wireless charging system, thereby ensuring the charging process proceeds in a safe and clean environment.

As a preferable embodiment, the side of the quadruped robot 30 near the ground is provided with a circuit board that is bare, and the power receiver 300 is mounted on the circuit board.

In this embodiment, the power receiver 300 is placed on the bare circuit board near the ground, which minimizes the physical distance between the power receiver 300 and the power transmitter 200 in the charging panel 20 while eliminating interference from intermediate media.

The bare circuit board means the power receiver 300 (typically a receiving coil) can be directly positioned above the charging panel 20, allowing the magnetic field generated by electromagnetic induction or resonant coupling to penetrate the coil of the power receiver 300 more directly and efficiently, thereby reducing energy loss. This layout takes advantage of the typical posture of the quadruped robot 30 during charging (lying prone or close to the charging panel 20), ensuring optimal alignment and minimal distance between the receiver and transmitter coils, thereby significantly improving the efficiency and stability of wireless energy transfer. Additionally, the bare circuit board facilitates heat dissipation, which maintains stable operating temperatures for the power receiver 300 during high-efficiency operation.

Moreover, to provide protection while maintaining exposure, a thin, magnetically permeable, and wear-resistant non-metallic protective layer, such as ultra-thin glass, high-strength ceramic coating, or polymer composite may be applied over the power receiver 300 and the circuit board. In such a way, the circuit board is protected from physical damage and environmental factors (e.g., dust, water splashes) without significantly affecting magnetic field coupling efficiency.

The coil of the power receiver 300 can be optimized as a multi-layer coil or a Litz wire to reduce the skin effect and proximity effect under high-frequency currents, thereby further improving the Q-factor of the coil and the energy conversion efficiency.

As a preferable embodiment, the quadruped robot 30 is further provided internally with a cooling fan oriented to blow air toward the circuit board.

The cooling fan may be an axial fan, centrifugal fan, or turbo fan, with its size and airflow capacity selected based on the internal space and cooling requirements of the quadruped robot 30. The installation direction of the cooling fan is suitable to ensure that the generated airflow is directed precisely and effectively toward the bare circuit board and the power receiver 300. For example, the cooling fan may be installed directly above or to the side of the circuit board, with a duct or internal air channel guiding relatively cool air from inside the quadruped robot 30 to the surface of the circuit board.

When the power receiver 300 begins operating and generates heat, or when its temperature reaches a preset threshold, the charging driver 301 or an independent temperature control module activates the cooling fan. The cooling fan accelerates the heat dissipation from the surface of the circuit board through forced convection, carries the heat away from the power receiver 300 and expels it through the exhaust vents of the quadruped robot 30, thereby effectively controlling the operating temperature of the power receiver 300 and preventing overheating. In such a way, the active cooling mechanism combined with the passive cooling of the bare circuit board forms an efficient integrated thermal management system.

It should be noted that, in addition to a single cooling fan, multiple small fans may be arranged in an array to cover the circuit board more uniformly or provide localized enhanced cooling based on the heat distribution. The control strategy for the cooling fans can be upgraded from simple on-off control to intelligent temperature-regulated speed adjustment, where integrated temperature sensors dynamically adjust the fan speed based on the real-time temperature of the power receiver 300 or the circuit board.

For example, when the temperature is below a preset threshold, the cooling fan may remain off or operate at a low speed to conserve energy and reduce noise. As the temperature rises, the fan gradually increases the speed to achieve precise and efficient cooling. The type of cooling fan may also be replaced with a micro centrifugal blower or turbo fan, which provides higher air pressure at the same size, making it suitable for space-constrained applications requiring directed airflow.

In addition to forced air cooling, heat pipes may be used to rapidly transfer the heat from the circuit board to the heat sinks or the outer shell inside the quadruped robot 30, where the heat can be dissipated by the cooling fan or natural convection. Furthermore, thermal pads or thermal gel may be added to the back of the circuit board or beneath the power receiver 300 to improve heat conduction efficiency from the power receiver 300 to the circuit board, after which the cooling fan performs the heat dissipation.

As a preferable embodiment, the charging driver 301 dynamically adjusts the charging power by monitoring the parameters of the rechargeable battery 302 such as the voltage, current, and temperature, and switches to a pulsed trickle charging mode when the battery capacity reaches a first preset value.

In this embodiment, the working principle of the charging driver 301 is based on closed-loop control using real-time feedback on the status of the rechargeable battery 302. The voltage, current, and temperature of the rechargeable battery 302 are monitored continuously. The voltage reflects the state of charge of the battery, the current indicates the charging rate, and the temperature is a critical indicator of battery health and safety.

The charging driver 301 dynamically adjusts the charging power delivered to the rechargeable battery 302 based on these parameters through an internal charging management algorithm. For example, during the initial charging phase, a constant-current mode is used for fast charging; when the voltage approaches full capacity, it switches to a constant-voltage mode; and if excessive battery temperature is detected, the charging current is reduced or charging is paused.

More importantly, when the battery capacity of the rechargeable battery 302 reaches a first preset value (e.g., 90% or 95%), the charging driver 301 intelligently switches to a pulsed trickle charging mode. The pulsed trickle charging works by intermittently supplying small current pulses to the battery instead of a continuous tiny current. This mode effectively reduces polarization effects and temperature rise inside the battery, allowing time for the internal chemical reactions to balance and recover, thereby completing the charging process more gently and thoroughly, avoiding overcharging, and helping to extend the cycle life of the battery.

The pulse parameters of the pulsed trickle charging mode (such as pulse width, pulse period, and pulse current magnitude) can be adaptively adjusted based on the real-time state of health, temperature, and charging stage of the rechargeable battery 302. For example, when the battery temperature is high, the pulse interval can be extended to reduce heat accumulation. In addition to pulsed trickle charging, negative pulse charging can also be employed, where brief discharge pulses are inserted between the charging pulses to further reduce the polarization effects, thereby improving the charging efficiency and the battery lifespan. The control algorithms of the charging driver 301 can adopt fuzzy logic control or neural network algorithms to achieve smarter and more adaptive charging management by learning the charge-discharge characteristics and aging patterns of the battery, rather than relying solely on preset thresholds for switching.

Furthermore, the charging driver 301 can work in conjunction with the communication device 303 of the quadruped robot 30 to upload data such as the state of health and the charging history of the rechargeable battery 302 to the cloud for remote monitoring and fault diagnosis, thereby achieving more comprehensive battery lifecycle management.

As a preferable embodiment, when the battery level of the rechargeable battery 302 falls below a second preset value, the navigation device automatically activates and guides the quadruped robot 30 to move to the location of the charging panel 20.

Specifically, the real-time battery level of the rechargeable battery 302 is continuously monitored by the power management unit (PMU) or the charging driver 301 inside the quadruped robot 30. The battery level is typically estimated through voltage, current integration (coulomb counting), or battery models and is expressed as a percentage.

When it is detected that the battery level of the rechargeable battery 302 is below the preset second threshold (e.g., set at 25% to ensure sufficient power for returning to the charging station), the power management unit sends a low-battery warning signal to the main controller of the quadruped robot 30. Upon receiving this signal, the main controller immediately interrupts the current task (if the task allows interruptions) and issues a command to the navigation device to initiate the autonomous charging procedure.

After receiving the command, the navigation device first uses sensors (such as LiDAR, visual sensors, or inertial measurement units (IMUs)) to perceive and locate the current environment, so as to determine the precise position of the quadruped robot 30. It then calculates an optimal path from the current position of the quadruped robot 30 to the location of the charging panel 20 based on pre-stored charging station location information and the current environmental map, taking into account factors such as obstacle avoidance and shortest distance. Finally, based on the path, it controls the legs or the wheel-driven system of the quadruped robot 30 to move autonomously and smoothly to a position directly above the charging panel 20, preparing for the subsequent wireless charging. The entire process requires no manual intervention, thus fully autonomous power management and charging for the quadruped robot 30 are achieved.

The second preset value can be dynamically adjusted based on the task type, endurance requirements, and battery state of health of the quadruped robot 30. For example, for quadruped robots performing critical tasks, the second preset value can be set higher (e.g., 40%) to ensure sufficient power for returning; for quadruped robots with low-power standby states, the second preset value can be set lower (e.g., 15%).

In addition to the traditional voltage and coulomb counting methods, battery level monitoring can also employ a battery management system (BMS), which can more accurately estimate the state of charge (SOC) and state of health (SOH) by comprehensively considering factors such as internal resistance, temperature, historical charge-discharge data, and aging models.

As an alternative embodiment, when the battery level falls below the preset value, the navigation device can make decisions based on task priority. Specifically, if the current task has extremely high priority, it can complete the critical part of the task before returning to charge. If the task has low priority or is already completed, it can return immediately for charging. In scenarios with multiple quadruped robots 30 working collaboratively, the navigation device can coordinate with a central scheduling system to uniformly allocate charging resources, avoiding conflicts where multiple quadruped robots 30 compete for the charging station simultaneously, thereby achieving charging queue management and load balancing for the charging station.

As a preferable embodiment, the detection device 304 continuously monitors the surface condition of the charging panel 20 during the charging process. If a foreign object is detected, the first signal is immediately generated and transmitted to the charging power supply 10 via the communication device 303 to interrupt the charging connection.

Specifically, after the charging power supply 10 is activated based on the second signal and establishes a charging connection, the detection device 304 does not enter a sleep state but remains operational, namely monitors the surface of the charging panel 20 in real time at a preset frequency (e.g., several frames or scans per second).

When the detection device 304 identifies new foreign objects (e.g., a suddenly appearing metal object or liquid spreading) in consecutive detection frames or scans that do not belong to the charging environment, a high-priority event is immediately triggered. The detection device 304 then generates the first signal, which carries an alarm message about the foreign object detection. The communication device 303 immediately transmits this first signal to the charging power supply 10. Upon receiving the first signal, the charging power supply 10 immediately executes an emergency shutdown procedure, cutting off power to the power transmitter 200, thereby quickly and effectively interrupting the wireless charging connection between the power transmitter 200 and the power receiver 300. This detection and rapid response mechanism ensures that the system can react promptly to any safety hazards during charging, thereby minimizing risks.

As a preferable embodiment, during the charging process, the alignment state and the charging efficiency between the power receiver 300 and the power transmitter 200 are monitored. If the charging efficiency falls below a third preset value, the position of the quadruped robot 30 is adjusted to optimize the alignment, and a signal is sent to the charging power supply 10 via the communication device 303 to maintain or increase the charging power.

Specifically, after the wireless charging connection is established, the power detection circuit inside the power receiver 300 continuously measures the received electrical power, while the charging power supply 10 also monitors the power output to the power transmitter 200. These data are exchanged in real time between the quadruped robot 30 and the charging station via the communication device 303 (e.g., a bidirectional communication system). The charging driver 301 or an independent charging management unit of the quadruped robot 30 calculates the real-time charging efficiency (e.g., the ratio of the output power of the power receiver 300 to the input power of the power transmitter 200) based on the received power data. This calculated result is compared with a preset minimum efficiency threshold (i.e., the third preset value).

If the calculated charging efficiency is below this preset value (e.g., below 80%), it is determined that the current alignment is poor or other efficiency losses exist. At this point, the main controller of the quadruped robot 30 activates the navigation device and instructs it to perform minor position adjustments. These adjustments are typically fine movements at the millimeter to centimeter level (e.g., translating a few millimeters forward, backward, left, or right, or rotating a few degrees at a small angle), rather than large-scale repositioning.

The quadruped robot 30 can perform precise fine adjustments using its legs or wheel-driven system to find the optimal coupling point. During the adjustment process, the quadruped robot 30 continuously monitors the charging efficiency until it rises above the preset value or reaches the optimum.

Simultaneously, to ensure stable power output, the communication device 303 of the quadruped robot 30 sends a power request signal to the charging power supply 10, informing the current alignment state and the desired charging power level. The charging power supply 10 then dynamically adjusts its output power based on this signal and its own capabilities to maintain or increase the power supply to the power transmitter 200, thereby ensuring stable and efficient charging of the rechargeable battery 302.

Additionally, besides indirectly judging the alignment state through charging efficiency, independent alignment sensors can also be used. For example, visual markers, infrared sensor arrays, or magnetic field sensor arrays can be integrated on the power receiver 300 and the power transmitter 200, respectively, to directly measure their relative positions and angular deviations, thereby more accurately assessing the alignment state.

The alignment optimization strategy can employ machine learning-based adaptive algorithms to predict the optimal adjustment direction and magnitude by learning historical charging data and alignment adjustment effects, thereby achieving smarter and faster alignment optimization.

In addition to translation and rotation, the position adjustment of the quadruped robot 30 can utilize fine movements of its leg joints or tilting adjustments of its chassis to achieve finer posture optimization, so as to adapt to transmitter coils of different shapes.

Furthermore, to improve the efficiency, guide slots or physical limits can be designed on the charging panel 20 to assist the quadruped robot 30 in preliminary alignment.

As a preferable embodiment, the circuit board is integrated with a multi-coil array structure, which dynamically switches an activated coil group via a relay matrix, in response to changes in coupling efficiency caused by positional or angular deviations of the charging panel 20.

In this embodiment, the bare circuit board near the ground on the quadruped robot 30 is integrated with a multi-coil array composed of multiple independent or partially overlapping receiving coils (e.g., 2×2, 3×3, or annularly arranged coils). Each coil or coil group is connected to the relay matrix via independent leads. The relay matrix consists of multiple programmable relays (e.g., solid-state relays or micro-electromechanical system (MEMS) relays), with each relay controlling the on/off state of one or a group of coils.

During the charging process, the charging driver 301 or an independent coil management unit detects the induced voltage, current, or coupling coefficient of each coil or preset coil combination in the multi-coil array. For example, the induced electromotive force of the coil can be measured by briefly activating each coil, or the coupling efficiency can be evaluated by using impedance matching algorithms.

When the quadruped robot 30 experiences positional or angular deviations on the charging panel 20, the charging driver 301 detects a decline in overall coupling efficiency and identifies which coil or coil group currently has the best coupling effect with the power transmitter 200. The relay matrix then receives the instructions to quickly switch and activate the coil group with the best coupling effect while disconnecting other poorly coupled coil groups.

This dynamic switching process can be completed within milliseconds, ensuring that the power receiver 300 always receives the energy at optimal or near-optimal efficiency when the position or posture of the quadruped robot 30 changes. For example, when the quadruped robot 30 shifts leftward, the relay matrix activates the left coil group; when the quadruped robot 30 tilts its head downward, the coil combination corresponding to the tilt angle may be activated.

For the charging method in this embodiment, first, by dynamically selecting the optimal coupled coil group, the positional deviations (e.g., ±5 cm) and angular deviations (e.g., ±10 degrees) of the quadruped robot 30 on the charging panel 20 can be effectively compensated, thereby significantly reducing the requirements for docking accuracy and making the charging process more convenient and user-friendly.

Second, even if the quadruped robot 30 is not perfectly aligned, the system can maintain high energy transfer efficiency by activating the optimal coil group, avoiding sharp efficiency drops due to poor alignment. In such a way, the stability and reliability of the charging process are ensured, thereby reducing charging interruptions or efficiency fluctuations.

Moreover, the multi-coil array structure allows the quadruped robot 30 to maintain normal operation despite inevitable alignment errors in practical applications, thereby enhancing the robustness and adaptability of the entire wireless charging system, especially for quadruped robots 30 operating in complex or dynamic environments.

As a preferable embodiment, the communication device 303 supports a bidirectional energy transfer protocol. During the charging process, the data of the state of health of the rechargeable battery 302 is fed back to the charging panel 20 via frequency-shift keying (FSK) modulation, thereby triggering the power transmitter 200 to adjust its resonant frequency to match the energy reception window of the power receiver 300.

In this embodiment, the communication device 303 of the quadruped robot 30 is integrated with a bidirectional data transceiver that can work in coordination with the energy reception circuit of the power receiver 300. While receiving the energy, the data signals are superimposed onto the wireless charging carrier using backscatter modulation or load modulation techniques to achieve data transmission from the quadruped robot 30 to the charging station.

During the charging process, the battery management system (BMS) of the rechargeable battery 302 continuously collects and processes the health state data, including but not limited to internal resistance, temperature, cycle count, charging history, and estimated actual capacity degradation. These raw data are received by the communication device 303 and encoded using FSK modulation.

The FSK modulation represents binary data by switching between two or more preset frequencies (e.g., frequency f1 for logic “0” and frequency f2 for logic “1”). This modulation method is simple and has strong anti-interference capabilities. The modulated data signal is injected into the load circuit of the power receiver 300 to change the load impedance of the power receiver 300, thereby affecting the carrier signal of the power transmitter 200, and forming data feedback.

These slight frequency changes are detected by the power transmitter 200 inside the charging panel 20, and then demodulated to recover the health state data D2 of the rechargeable battery 302. These data D2 are then transmitted to the control unit of the charging power supply 10. Based on the received data, the control unit intelligently determines the optimal charging characteristics and requirements of the rechargeable battery 302. For example, if the internal resistance of the battery increases or the temperature deviates from the ideal range, the charging frequency may be adjusted. Accordingly, the charging power supply 10 dynamically adjusts the resonant frequency of the power transmitter 200 to precisely match the current optimal energy reception window of the power receiver 300.

Such a dynamic frequency adjustment maximizes the energy transfer efficiency, reduces the losses, and optimizes the charging based on the actual health condition of the battery, thereby extending the overall lifespan of the rechargeable battery 302.

The above disclosure is only preferred embodiments of the present invention and cannot be used to limit the scope of rights of the present invention. Therefore, any equivalent changes made in accordance with the claims of the present invention are within the scope of the present invention.

What is claimed is:

1. A wireless charging method for an intelligent quadruped robot, the quadruped robot being equipped with a power receiver, a charging driver, a navigation device, a communication device, and a detection device; and the wireless charging method comprising:
providing a charging station, the charging station comprising a charging power supply and a charging panel electrically connected to the charging power supply, the charging panel being provided with a power transmitter capable of wirelessly transmitting an electrical energy signal;
guiding the quadruped robot to the charging panel based on the navigation device;
detecting a surface condition of the charging panel via the detection device, generating a first signal once a foreign object is present on the charging panel, otherwise, generating a second signal;
transmitting the first signal or the second signal to the charging power supply via the communication device;
controlling the charging power supply in a turned-off state when the charging power supply is idle; remaining the charging power supply in the turned-off state when the first signal is received; and switching the charging power supply from the turned-off state to a turned-on state when the second signal is received, thereby establishing a charging connection between the power transmitter and the power receiver; and
receiving, by the charging driver, the electrical energy signal from the power receiver to charge a rechargeable battery in the quadruped robot.

2. The wireless charging method according to claim 1, wherein the detection device comprises a camera and/or a detection radar.

3. The wireless charging method according to claim 1, wherein a side of the quadruped robot is provided with a circuit board, and the power receiver is arranged on the circuit board.

4. The wireless charging method according to claim 3, wherein the quadruped robot is further provided internally with a cooling fan oriented toward the circuit board.

5. The wireless charging method according to claim 1, further comprising adjusting, by the charging driver, the charging power in real time by detecting parameters including voltage, current, and temperature of the rechargeable battery, and switching to a pulsed trickle charging mode when a battery capacity of the rechargeable battery reaches a preset value.

6. The wireless charging method according to claim 1, further comprising automatically activating and guiding, by the navigation device, the quadruped robot to move to a location of the charging panel, when the battery level of the rechargeable battery is lower than a preset value.

7. The wireless charging method according to claim 1, further comprising continuously monitoring, by the detection device, a surface condition of the charging panel during a charging process, and generating the first signal once the foreign object is detected, and transmitting the first signal to the charging power supply via the communication device to interrupt the charging connection.

8. The wireless charging method according to claim 1, further comprising during a charging process, detecting an alignment state between the power receiver and the power transmitter and a charging efficiency, adjusting a position of the quadruped robot when the charging efficiency is lower than a preset value, and sending a signal to the charging power supply via the communication device to maintain or increase the charging power.

9. The wireless charging method according to claim 3, wherein the circuit board is integrated with a multi-coil array structure, and the wireless charging method further comprises dynamically switching an activated coil group via a relay matrix, in response to changes in coupling efficiency caused by positional or angular deviations of the charging panel.

10. The wireless charging method according to claim 1, wherein the communication device supports a bidirectional energy transfer protocol, and the wireless charging method further comprises during a charging process, feeding back health state data of the rechargeable battery to the charging panel via frequency-shift keying modulation, and triggering the power transmitter to adjust a resonant frequency to match an energy reception window of the power receiver.
